(19) United States
(12) Patent Application Publication
(10) Pub. No.: US 2008/0270296 A1
(43) Pub. Date: Oct. 30, 2008

(54) Method and system for operating a risk management call center

(76) Inventors: Janice Zhou, Midland, GA (US); Jane Hua He, Midland, GA (US); Aruna Shankar, Midland, GA (US)

Correspondence Address: KING & SPALDING LLP, 1180 PEACHTREE STREET, ATLANTA, GA, 30309-3521, US

(21) Appl. No.: 12/150,377

(22) Filed: Apr. 28, 2008

Related U.S. Application Data
(60) Provisional application No. 60/926,552, filed on Apr. 27, 2007.

(51) Int. Cl. G06Q 40/00

(52) U.S. Cl. 705/38

(57) ABSTRACT

Operating a risk management call center. The systems and methods receive a risk related inquiry; automatically locate the associated financial account data; display appropriate workflows on a graphical user interface; perform workflows comprising automatic navigation among the steps; ensure compliance with certain predetermined rules specific to a account-provider, business, or regulation; and store all activity and data related to each risk related inquiry. The systems and methods include an agent workstation, a workflow engine, a host computer system, and a workflow database. The agent workstation communicates with the workflow engine, which stores the workflows. The workflow engine communicates with the host computer system to access the financial account data. The workflow engine also communicates with a workflow database, which stores all activity and data related to each risk related inquiry for purposes of tracking, billing, statistics, and research.

### STATEMENT OF RELATED PATENT APPLICATIONS

This non-provisional patent application claims priority under 35 U.S.C. § 119 to U.S. Provisional Patent Application No. 60/926,552, titled Method and System for Operating a Risk Management Call Center, filed Apr. 27, 2007. This provisional application is hereby fully incorporated herein by reference.

### FIELD OF THE INVENTION

This invention relates to systems and methods for operating a risk management call center. More particularly, this invention relates to processes and systems that allow call center representatives or other users to more efficiently access customer data in order to manage risk related calls pertaining to financial accounts.

### BACKGROUND OF THE INVENTION

The use of financial cards for conducting financial transactions is ubiquitous. Typically, a credit card represents a line of credit that has been issued from a financial institution, the account provider, to an individual, the account holder. The credit card allows the account holder to purchase goods and services against the line of credit. The line of credit is associated with an account and that account has certain terms governing how credit is extended to the account holder. Typical terms include an annual interest rate charged on the amount of money actually lent to the account holder, a grace period that allows the account holder to pay for purchases without incurring interest charges, annual fees for the account, and other fees, such a late payment fees. Credit cards may be issued by national card associations, such as AMERICAN EXPRESS or DISCOVER CARD; a financial institution in conjunction with a national card association, such as a Bank of America VISA or MASTERCARD; or directly from a retailer, such as MACY'S or BRITISH PETROLEUM.

In addition to credit cards, debit cards allow an account holder to withdraw funds directly from their bank account. Accordingly, purchases are not made on credit, but with funds in an account linked to the particular debit card. Generally, debit cards are issued by financial institutions.

Prepaid cards provide another method to make purchases. A prepaid card has access to a predetermined amount of funds. The predetermined amount is paid in advance of using the card. Each time it is used, the amount of a purchase is deducted from the prepaid amount.

Credit cards, debit cards, and prepaid cards are used by account holders to make purchases at a variety of institutions. However, certain risk related issues can affect an account holder's ability to use the card in its conventional manner. Such events can lead an account holder to inquire on their account to prevent or identify fraud. For example, a credit card or debit card could be lost or stolen or the account holder could become aware of unusual charges indicating a potentially fraudulent use. These are just a few examples of such risk related inquiries.

When such an event occurs, the account holder generally calls a risk management center that is operated by a processor, in conjunction with or at the direction of the issuing financial institution or credit card association. The account holder typically speaks to a risk management call center representative, or agent, to detail their inquiry.

In addressing such risk related inquiries, an agent first accesses the account holder's financial account information. In the conventional system, the agent accesses data stored in multiple systems or regions. The agent does this manually, directly accessing the mainframe and viewing the information on a mainframe screen. In addressing the risk related inquiry, the agent again manually navigates through the mainframe screens to view information. The agent is not prompted to perform any particular step, nor to view any particular data. Further, the agent is not provided with an interface with straightforward menu selections. Because of the manual nature of the process, an agent can sometimes overlook a necessary step in the process, violate a business or compliance rule that applies to the account; and spend an inordinate amount of time researching the inquiry on the mainframe system. A business or compliance rule is a rule instituted by the account-provider or provided for in regulations that govern how risk related inquiries are to be handled. Finally, the conventional system does not provide for storage of the agent's activities. As such, conventional methods do not allow for tracking an account holder's call for future reference, billing, or research purposes.

The typical process for managing calls at a risk management call center is thus an inefficient, time-consuming, and potentially error-ridden process. In addition, the agent's activity could not be adequately tracked for purposes of billing, research, and analysis. The conventional process also lead to violation of business or compliance rules, as the rules are not readily available and agents must perform them manually. Accordingly, a need exists for systems and methods that streamline the process of risk management and ensure compliance with applicable rules, thus improving risk handling, providing greater efficiencies, fewer mistakes, and tracking capability.

### SUMMARY OF THE INVENTION

The present invention supports systems and methods for operating a risk management call center to ensure compliance with account-provider, business, and regulatory rules. “Account-provider” is used herein to refer to the account issuing entity, such as the national card association or financial institution. The systems and methods automate the process of identifying the financial account associated with a risk related inquiry among multiple systems and regions. In addition, the systems and methods provide automatic display of available workflows and ensure compliance with the account-provider, business, and regulatory rules when workflows are performed. “Workflows” as used herein refer to actions taken in response to a risk related inquiry, and may include: accessing data associated with a financial account, manipulating data associated with the financial account, performing an activity in relation to the financial account, and/or linking to another workflow. For example, workflows can include accessing the latest transaction on a financial account; blocking a financial account from future use, and ordering a new card. The workflows described herein are complete sets of “instructions” provided to the agent through a graphical user interface that provide the agent with the necessary data, forms, and questions to effectively handle the risk related inquiry without missing steps or violating a business or compliance rule. In other words, the workflows provide automatic navigation among their various steps, automatically displaying screens and prompting the agent to address certain issues. The systems and methods may also provide the ability to track and store activity performed in response to a risk related inquiry.

In one aspect of the invention, the system provides for efficient operation of a risk management call center and includes agent workstations that are connected to a network. The system is operable to receive a risk related inquiry; identify a financial account associated with the risk related inquiry; automatically identify a location of data associated with the financial account among multiple computer systems and mainframe regions; display workflows corresponding to the financial account on a graphical user interface, the workflows based predetermined rules; perform workflows in response to the risk related inquiry; provide automatic navigation through the workflows; and store data related to the risk related inquiry in a workflow database.

Yet another aspect of the present invention provides a method for operating a risk management call center. This method includes the steps of (a) receiving a risk related inquiry; (b) identifying a financial account associated with the risk related inquiry; (c) accessing data associated with the financial account; (d) displaying data associated with the financial account and workflows on a graphical user interface; (e) performing the workflow on the financial account, where the workflows are based on predetermined rules; (f) storing the workflows performed on the financial account in a workflow database.

Yet another aspect of the present provides a system for operation of a financial account risk management call center. This system provides an agent workstation that includes a risk management module operable to receive data related to a risk related inquiry and display a graphical user interface including workflow options. The workflow engine is logically connected to the agent workstation and is operable to automatically identify a location of financial account data associated with the risk related inquiry within a host computer system, store workflows based on predetermined rules, and ensure compliance with the predetermined rules during performance workflows, where the workflows comprises automatic navigation. The host computer system is logically connected to the workflow engine and includes financial account data for financial accounts. The system also includes a workflow database, logically connected to the workflow engine, and operable to store data associated with the risk related inquiry.

### BRIEF DESCRIPTION OF THE DRAWINGS

FIG. 1 depicts a system architecture in accordance with an exemplary embodiment of the present invention.

FIG. 2 depicts a system architecture in accordance with an exemplary embodiment of the present invention.

FIG. 3 depicts an overall process flow diagram for providing an automated risk management call center in accordance with an exemplary embodiment of the present invention.

FIG. 4 depicts a detailed process flow diagram for providing an automated risk management call center in accordance with an exemplary embodiment of the present invention.

### DETAILED DESCRIPTION OF THE EXEMPLARY EMBODIMENTS

Exemplary embodiments of the present invention are provided. These embodiments include systems and methods that provide for the efficient operation of a risk management call center for managing a risk related inquiry. The systems and methods include the ability to receive a risk related inquiry; automatically locate the associated financial account data among multiple systems and regions; display appropriate workflows on a graphical user interface; perform workflows on the associated financial account comprising automatic navigation; ensure compliance with certain predetermined rules specific to a account-provider, business, or regulation; and store activity and data related to each risk related inquiry. The systems and methods include an agent workstation, a workflow engine, a host computer system, and a workflow state store. The agent workstation communicates with the workflow engine, which stores and applies the predetermined rules. The workflow engine communicates with the host computer system to access the financial account data. The workflow engine also communicates with a workflow state store, which stores all activity and data related to each risk related inquiry for purposes of tracking, billing, statistics, and research.

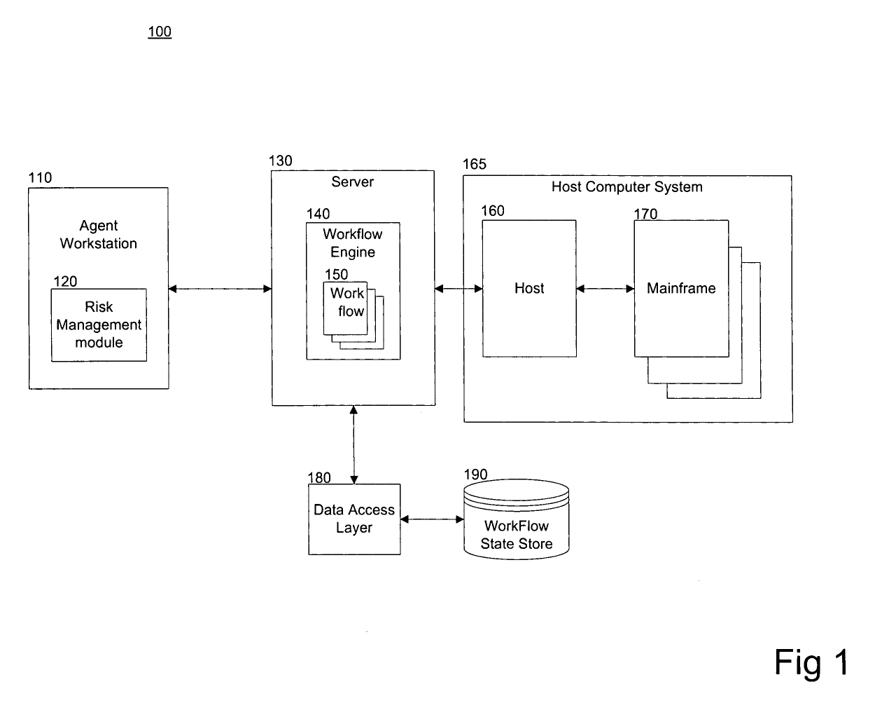

FIG. 1 depicts a system architecture 100 in accordance with an exemplary embodiment of the present invention. Referring to FIG. 1, the system architecture 100 includes an agent workstation 110. An agent is a representative at a risk management call center. The agent workstation 110 may be part of a local area network (LAN), wide area network, including the Internet, or a part of both types of networks. The agent workstation 110 may be connected to one or more computer (not shown) that control the programming and operation of the agent workstation 110. In this exemplary embodiment, the agent workstation 110 is used by an agent to process consumer calls related to risk. Each risk related call represents a financial account where the associated account holder has a identified a risk related issue. In an exemplary embodiment, the agent receives information verbally from the consumer account holder regarding the risk related activity. In certain alternative embodiments, the agent can receive financial account risk related activity from other sources. For example, from electronic mail and files.

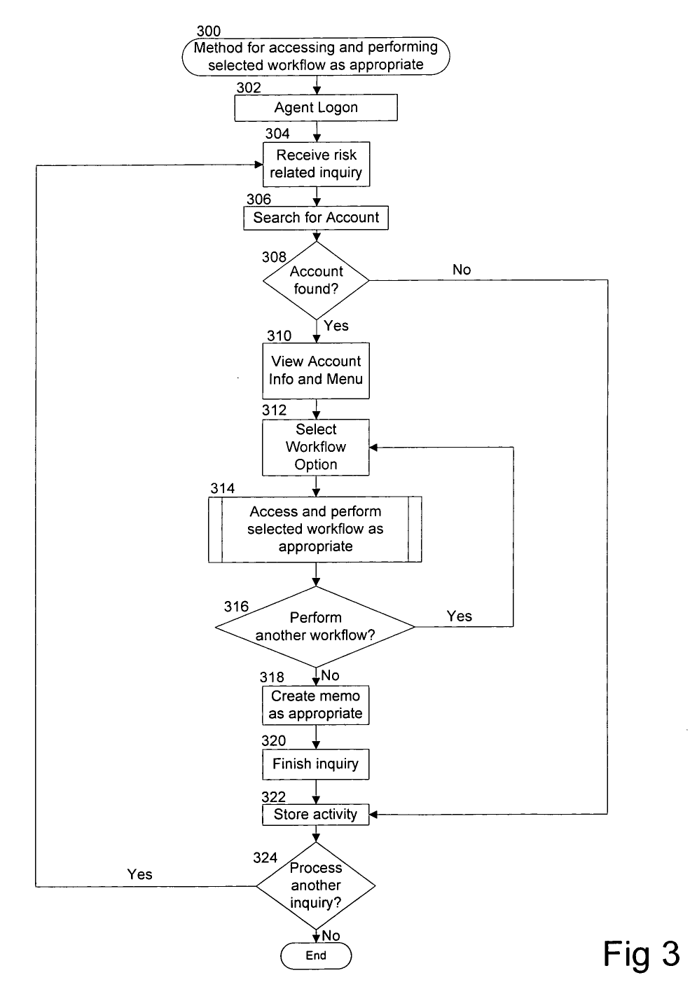

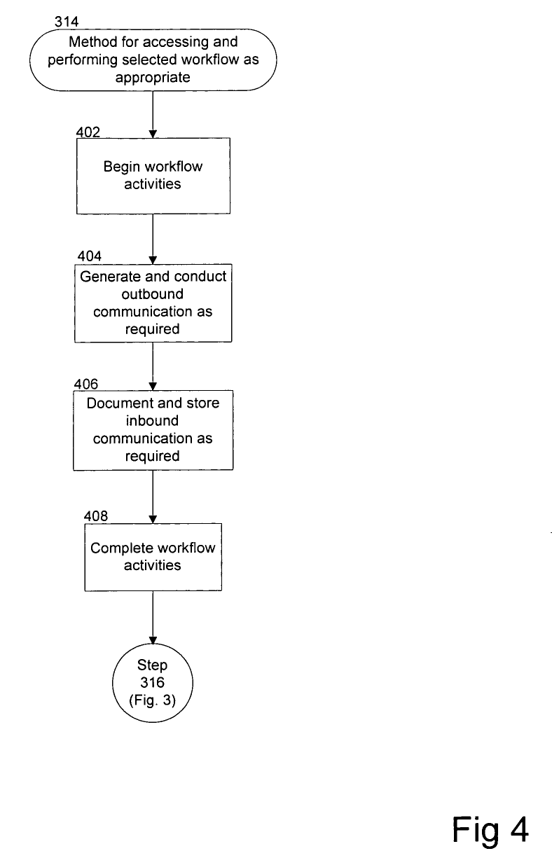

The agent workstation 110 includes a risk management module 120. The risk management module 120 is an application that has a graphical user interface (GUI) and operates on the agent workstation 110. The risk management module 120 allows the representative using the agent workstation 110 to efficiently access account holder data and perform workflows to handle the risk related inquiry. The workflows and GUI will be described in more detail herein with reference to FIGS. 3-4.

The agent workstation 110 communicates with a server 130. The server 130 includes a workflow engine 140. The workflow engine 140 is an application that stores the various workflows 150 that can be accessed to handle the risk related inquiries. The workflow engine 140 also stores business and regulatory rules related to management of risk related activity on a consumer's account. The workflows will be described in more detail herein with reference to FIG. 4.

The workflow engine 140 operates workflows 150, which apply the relevant business or regulatory rules, to efficiently and effectively manage the risk related inquiry. Particular workflows 150 will be described in more detail herein below with reference to FIG. 4. When certain workflows 150 are applied, the workflow engine 140 can initiate access to the host computer system 165 to automatically access the relevant account holder data. As such, the agent need not separately log in to the host computer system 165, as this step is performed by the workflow engine 140. An administrator can access the workflow engine 140 to add, delete, or change the business or compliance rules and/or the workflows 150. Generally speaking, business or compliance rules are requirements that govern how a risk related inquiry is to be managed, and are instituted by the account-provider, provided for in regulations related to managing potentially fraudulent activity, or designated internally by a financial account processor.

In this exemplary embodiment, the host computer system 165 includes a host 160. The host 160 is a large data processing system and can store and access information related to the consumer's account. The host 160 can access mainframes 170, where account information can be stored. When the host computer system 165 is accessed by the server 130, the host 160 locates the requested data among the mainframes 170. When the server 130 accesses the host computer system 165, the host 160 is activated to locate the requested data among the mainframes 170. Account holder data is stored among the mainframes 170 based on account-provider. Such data includes account holder information; account history; recent charges; and other data related to the account. Additionally, because the server 130 communicates with the agent workstation 110, data obtained from the mainframes 170 can be displayed on the GUI of the workstation 110.

The server 130 can also communicate with a data access layer 180. The data access layer 180 captures the activity of the workflow engine 140. Activity of the workflow engine 140 includes the workflows performed, business or regulatory rules applied, and data accessed through host 160. In other words, the data access layer 180 can capture the inquiries made and actions performed on the account in relation to a risk related inquiry from an account holder. In addition, the data access layer 180 can capture other attributes of the risk related inquiry. For example, the data access layer 180 can capture the amount of time spent by an agent handling the risk related inquiry.

The data access layer 180 communicates with the workflow state store 190. The workflow state store 190 is a database used to store the activity captured by the data access layer 180. The workflow state store 190 stores such data for purposes of billing, tracking, and research as it pertains to risk related inquiries. An administrator can access the workflow state store 190 for such purposes.

The system architecture 100 thus allows for the retrieval of information stored on mainframes 170 without requiring the agent to directly access the host 160 to navigate among the mainframes 170. In addition, the information retrieved is displayed on the agent workstation 110 through a GUI provided by the risk management module 120.

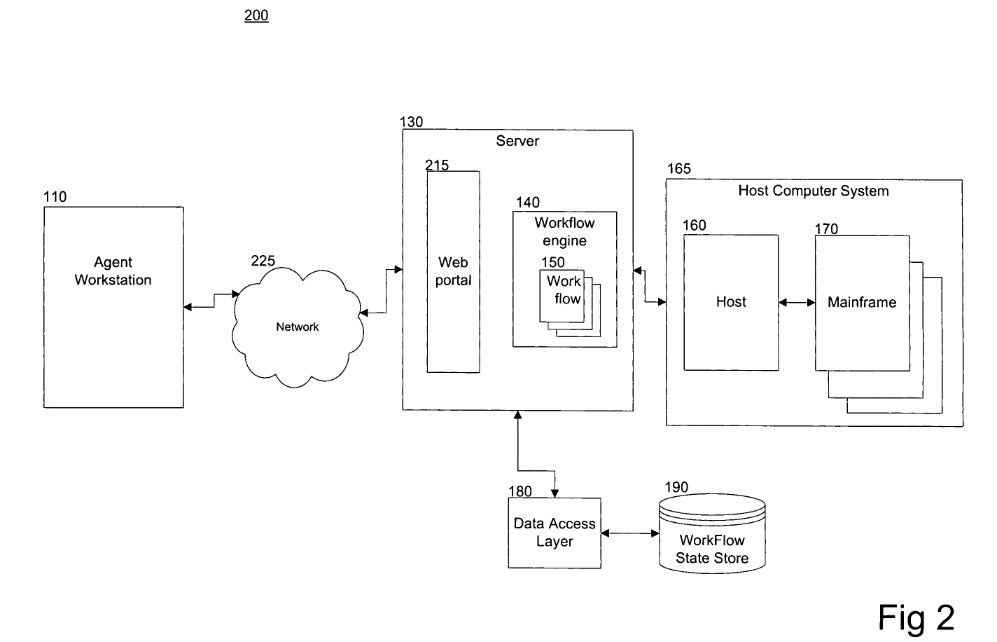

FIG. 2 depicts a system architecture 200 in accordance with an exemplary embodiment of the present invention. FIG. 2 is largely the same as FIG. 1, and the differences will be described herein with reference to FIG. 1. In FIG. 2, the server 130 includes a web portal 215. The web portal 215 provides access to the functionality of the server. The network 225 can be the Internet, a dedicated communication line, shared network switch or other suitable network. As shown in FIG. 2, the agent workstation 110 can communicate by way of the network 225 with the server 130 using the web portal 215. In this embodiment, the workstation 110 need not include a risk management module 120 because the workstation 110 is capable of accessing the application in a different location by using a thin client application, such as a web browser. Accordingly, the risk management module 120 can be located on the server 130, or in another location accessible via the network (not shown).

FIG. 3 depicts an overall process flow diagram 300 providing a system for operating a risk management call center in accordance with an exemplary embodiment of the present invention. Referring to FIG. 1, a process for operating a risk management call center can be described. FIG. 4, discussed in detail below, provides additional details on this overall process.

At step 302, an agent, such as a risk management call center representative, logs on to the agent workstation 110. In particular, the agent accesses the risk management module 120 on the agent workstation 110. The risk management module 120 provides the agent with a GUI login screen. The agent uses an assigned login identification and password to logon to the agent workstation 110. In general, all activity performed by an agent in relation to the financial account is conducted using the GUI displayed on the agent workstation 110.

At step 304, the agent receives a risk related inquiry from an account holder regarding the account. For example, the risk related inquiry can include information such as: the account number; the bank; account name; suspicious activity on the account; lost card; stolen card; and address change.

At step 306, the risk management module 120 searches for the account holder's account using information received at step 304. In an exemplary embodiment, the agent enters the account holder's account number using the GUI provided by the risk management module 120. In another exemplary embodiment, the agent can search for the account holder's account by searching by bank or account-provider. Upon entry of such information, the agent workstation 110 communicates with the workflow engine 140 on the server 130. The workflow engine 140 initiates access with the host computer system 165 to locate information regarding the account number entered at step 306. Accordingly, the agent need not directly interface with the host computer system 165.

At step 308, the risk management module 120 determines whether the financial account is identified. The financial account is identified if it is located among the mainframes 170. If the financial account is identified at step 308, the method proceeds to step 310. If the financial account is not identified, the method proceeds to step 322, described in more detail herein below.

At step 310, the GUI display on the agent workstation 110 displays the account information. In addition, the GUI displays multiple menu options that lead to various workflows 150. In an exemplary embodiment, the GUI displayed at step 310 includes menu options that lead to workflows 150 including: “add/remove watch;” “pin request;” letter request;” “card request;” “balance transfer;” “call request;” “add/remove auth user;” “open/close account;” “name/address change;” balance adjustment;” “lost & stolen;” “add memo;” “next memo;” “order card;” “dispute charge;” “review charges;” “retention qualification;” “APR info;” “convenience checks;” “view events;” and/or other account related activities. The workflow engine 140 customizes the menu options displayed on the GUI by agent, account, and/or account-provider. Accordingly, the list of optional workflows displayed at step 310 may include greater than or fewer than those listed here, depending on the agent, the account, and/or the account-provider.

At step 312, the agent selects a workflow 150 from the menu options displayed at step 310. In an exemplary embodiment, the agent can select the workflow by clicking on the GUI. The particular workflows will be described herein with reference to FIG. 4.

At step 314, the workflow 150 selected at step 312 is accessed and performed as appropriate. Step 314 is described in more detail herein below with reference to FIG. 4.

At step 316, the agent determines whether another workflow 150 is to be performed with regard to the financial account identified at step 306. Each workflow 150 includes a sequence of steps, displayed among one or more screens, to ensure that the workflow is completed efficiently and accurately. In addition, an agent can manually select an additional workflow 150, based on the risk related inquiry. Further, the workflow engine 140, in response to completion of a particular workflow, can prompt the agent to perform an additional workflow 150. For example, if a lost card report is made, the workflow engine 140 will prompt the agent to determine whether a new card needs to be ordered on the account. Accordingly, the workflow engine automates the navigation of workflows 150 for the agent. If another workflow is to be performed, the method proceeds to step 312, and the method proceeds as described previously herein. If another workflow is not to be performed, then the method proceeds to step 318.

At step 318, the agent can create a memo to document the risk related inquiry received at step 304. For example, the agent can type notes into the memo indicating particular details related to the account, the account holder, the issues, and/or the action taken on the account.

At step 320, the agent finishes the call. In an exemplary embodiment, the agent enters the type of call from a drop-down menu. For example, the agent can select that the call was related to one of the following types: “card request;” dispute inquiry;” fraud application;” fraud call back;” “fraud inquiry;” “account review.”

At step 322, the activity during the call is stored in the workflow data store 190. More particularly, the data access layer 180 continuously captures the activity performed, as it relates to a risk related inquiry, by communicating with the server 130. The workflow state store 190 stores this data as described herein with reference to FIG. 1. The activity captured by the data access layer 180 and stored by the workflow state store includes: the particular workflow(s) that were selected, accessed, and/or performed. The data access layer 180 also captures data related to the inquiry including: the account number; duration of the call; memos made at step 318; and other call-related measures. An administrator can access the workflow state store 190 to efficiently obtain information related to each risk related inquiry, for purposes of billing a account-provider, tracking agent efficiency, and for statistical and research purposes.

At step 324, a determination is made whether to process another inquiry. If it is determined to process another inquiry, the method proceeds to step 304, and the method proceeds as previously described herein. If the determination is made to not process another inquiry, the method ends.

FIG. 4 depicts a detailed process flow diagram for providing a method 314 for operating a risk management call center in accordance with an exemplary embodiment of the present invention. The method will be described herein with reference to FIGS. 1-4.

At step 402, the workflow engine begins performance of the workflow 150 selected at step 314 of FIG. 3. The workflow engine 140 begins performance by accessing the appropriate workflow 150. Each workflow 150 embodies account-provider, business, and regulatory specific rules. Accordingly, when the particular workflow is selected and performed, the workflow is carried out in a manner that is compliant with these rules. For example, a particular account-provider may prohibit certain workflows from being performed on their account holders' accounts or require that they are performed in a certain manner. As an example, VISA may prohibit a financial account from being blocked outside the United States in response to a report of a lost card.

The step of beginning performance of a workflow also includes displaying screens associated with the workflow 150 on the GUI. The screen may take on a variety of formats. For example, the screens can display information about the account, such as recent charges; menu options; and/or forms. Aspects of a workflow 150 can be displayed on a single screen, multiple screens, or be embodied in the current display of the agent workstation 110. Certain workflows include multiple steps, and thus require the agent to proceed through all the necessary steps of each workflow. For example, for a risk related inquiry regarding a “dispute,” the workflow for “dispute” prompts the agent to complete a form and add additional comments; the agent cannot proceed to a new workflow without first navigating through the entire “dispute” workflow. In other words, the workflows provide automatic navigation among the various steps, thus ensuring that an agent cannot overlook a particular step. Accordingly, the workflows 150 can essentially walk the agent through screens, wherein the coding behind the screens can efficiently provide the relevant information and perform the requisite activities to ensure effective management of a risk related inquiry. Further, multiple workflows 150 can be performed in sequence, and one workflow can automatically link to another workflow. As such, workflows may be performed in varying sequences to ensure that the risk related inquiries are handled most efficiently. As such, workflows may be performed in varying sequences to ensure that the risk related inquiry is handled most efficiently. The workflow engine thus streamlines the approach to managing risk related inquiries.

The data necessary to perform any of the workflows 150 are obtained when the workflow engine 140 initiates access to the host computer system 165, which locates the data among the mainframes 170. In turn, the data is displayed on the GUI on the agent workstation 110.

At step 404, the agent, through the agent workstation 110, generates and conducts any outbound communications as required by the workflow 150. Outbound communications may include letters, telephone calls, emails, and/or another type of communication. An outbound communication can include a telephone call or a letter. In an alternative embodiment, an outbound communication can include an electronic message, a text message, and an instant message. In an exemplary embodiment, the agent places the outbound communication, such as a telephone call.

At step 406, the agent, through the agent workstation 110, documents and stores any inbound communications received, as required by the workflow 150. Inbound communications may include letters from account holders and sales drafts from merchants. The agent can document the receipt of such communications, as well as other details regarding the communication. The workflow engine 150 provides the requisite navigation and prompting of the agent to ensure that inbound communications are properly stored and documented.

At step 408, the workflow is completed. As described above with reference to step 402 of FIG. 4, the workflows can include a sequence of steps and display information using multiple screens. Completion of the workflow at step 408 simply means to perform any remaining steps of a the workflow selected at step 312 of FIG. 3.

The workflow engine 140 thus streamlines the approach to managing risk related inquiries. Provided herein are just a few examples of the many available types and configuration of workflows, and other workflows and workflow configurations can be made without departing from the spirit and scope of the invention.

One of ordinary skill in the art would appreciate that the present invention supports systems and methods for operation of a risk management call center. The systems and methods may include the ability to submit risk related inquiries through a variety of platforms, including electronic mail, formatted file, or directly from a financial account processing system. The systems and methods interact with a host computer system and a server to manage the risk related inquiry.

Although specific embodiments of the present invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed:

1. A system for operation of a risk management call center comprising:
an agent workstation operable to:
receive a risk related inquiry;
identify a financial account associated with the risk related inquiry;
automatically identify a location of data associated with the financial account among a computer systems and a mainframe region;
display a list of workflow options corresponding to the financial account on a graphical user interface, the workflow based a predetermined rule;
perform the workflow in response to the risk related inquiry;
provide automatic navigation through the workflow; and
store data related to the risk related inquiry in a workflow database.

2. The system of claim 1, wherein the risk related inquiry comprises at least one of an account number, a bank, a credit card association, a name, a social security number, and another type of account identifier.

3. The system of claim 1, further comprising a workflow engine, operable to store the predetermined rule.

4. The system of claim 3, wherein the workflow engine runs the workflow.

5. The system of claim 1, wherein the predetermined rule corresponds to at least one of account-provider-specific, business-specific, and regulatory requirements.

6. The system of claim 1, wherein the workflow comprises steps corresponding to performing an activity in relation to the financial account.

7. The system of claim 1, further comprising a data access layer, operable to capture data related to the risk related inquiry to be stored in the workflow database, the data related to the risk related inquiry comprising at least one of: the financial account; the workflows performed; the data accessed; and other data related to the risk related inquiry.

8. The system of claim 1, wherein an administrator can access the database operable to store the workflow performed in response to the risk related inquiry for purposes of at least one of: billing, tracking, statistical compilations, and research.

9. A method for operating a risk management call center, comprising the steps of:
a) receiving a risk related inquiry;
b) identifying a financial account associated with the risk related inquiry;
c) accessing data associated with the financial account;
d) displaying data associated with the financial account and a list of workflow options on a graphical user interface;
e) performing the workflow on the financial account, wherein the workflow is based on a predetermined rule; and
f) storing the workflow performed on the financial account in a workflow database.

10. The method of claim 9, wherein the risk related inquiry is received from one of: a financial account holder telephone caller, an electronic mail message, a fraud detection system, and another method of receiving risk related inquiries.

11. The method of claim 9, wherein the risk related inquiry comprises at least one of an account number, a bank, a credit card association, a name, a social security number, and another type of account identifier.

12. The method of claim 9, wherein the step of identifying a financial account associated with the risk related inquiry comprises accessing a host computer system.

13. The method of claim 12, wherein the host computer system comprises a mainframe computer system.

14. The method of claim 9, wherein the predetermined rule corresponds to at least one of account-provider-specific, business-specific, and regulatory requirements.

15. The method of claim 9, wherein the workflow comprises steps that correspond to performing an activity related to risk management of a financial account.

16. The method of claim 15, wherein the workflow further comprises automatic navigation through the steps that correspond to performing an activity related to risk management of a financial account.

17. The method of claim 9, wherein the step of performing the workflow on the financial account further comprises preventing performance of the workflow if it is not compliant with the predetermined rule.

18. The method of claim 9, wherein the step of storing the workflow performed on the financial account in a workflow database further comprises capturing data related to the risk related inquiry through a data access layer.

19. The method of claim 9, wherein an administrator can access the workflow database for purposes of at least one of: billing, tracking, statistical compilations, and research.

20. A system for operation of a financial account risk management call center comprising:
an agent workstation, comprising a risk management module operable to:
receive data related to a risk related inquiry;
display a graphical user interface comprising a list of workflow options; and
the workflow engine, logically connected to the agent workstation and operable to:
automatically identify a location of financial account data associated with the risk related inquiry within a host computer system;
store a workflow based on a predetermined rule; and
ensure compliance with the predetermined rule during performance of the workflows, wherein the workflow comprises automatic navigation;
the host computer system, logically connected to the workflow engine and comprising financial account data for a financial account;
a workflow database, logically connected to the workflow engine, operable to store data associated with the risk related inquiry.

21. The system of claim 20, wherein the predetermined rule comprises rules particular to at least one of: a bank, a credit card association, a regulatory agency, a law, and a business.

22. The system of claim 20, wherein the workflow engine is further operable to prohibit performance of workflows that violate the predetermined rule.

23. The system of claim 20, wherein the workflow comprises steps corresponding to performing an activity related to risk management of a financial account.

24. The system of claim 20, wherein an administrator can access the workflow engine for purposes of adding, deleting, and changing the predetermined rule.

25. The system of claim 20, wherein the host computer system comprises a mainframe computer system.

26. The system of claim 20, wherein the data associated with the risk related inquiry and stored by the workflow database comprises at least one of: the workflows performed in response to the risk related inquiry; the financial account data; the location of the financial account data; and other properties of the risk related inquiry.

27. The system of claim 20, wherein an administrator can access the workflow database for purposes of at least one of: billing, tracking, compiling statistics, and research.
